(19) United States
(12) Patent Application Publication
(10) Pub. No.: US 2023/0228277 A1
(43) Pub. Date: Jul. 20, 2023

(54) CENTRIFUGAL FAN AND ROTARY ELECTRIC MACHINE

(71) Applicant: Mitsubishi Electric Corporation, Tokyo (JP)

(72) Inventors: Shinichiro MINAMI, Tokyo (JP); Keisuke TAKEISHI, Tokyo (JP)

(73) Assignee: Mitsubishi Electric Corporation, Tokyo (JP)

(21) Appl. No.: 17/928,840

(22) PCT Filed: Jun. 10, 2020
(86) PCT No.: PCT/JP2020/022776

§ 371 Date: Nov. 30, 2022

(51) Int. Cl. F04D 29/30; F04D 17/08

(52) U.S. Cl. CPC F04D 29/30; F04D 17/08

(57) ABSTRACT

A centrifugal fan includes: a main plate having a rotation center; and a plurality of blades extending from the main plate in a direction of a rotation axis passing the rotation center. A length direction of each blade extends from an inner circumferential side to an outer circumferential side of the main plate. Where a distance between a forward edge of the blade and the rotation center is defined as RA and a distance between the rotation center and a point C between the forward edge and a backward edge of the blade is defined as RC, at least one of the plurality of blades has the point C that satisfies RC<RA.

### TECHNICAL FIELD

The present disclosure relates to a centrifugal fan and a rotary electric machine.

### BACKGROUND ART

One conventional example of so-called centrifugal fans is disclosed in Patent Document 1, and is used for sending a gas such as air or a liquid such as a coolant. This centrifugal fan includes a plurality of blades arranged in the circumferential direction, and includes a disk-shaped or bowl-shaped hub at one end in the axial direction of the blades and an annular shroud at an end opposite to the hub.

In Patent Document 1, a connection part between the bowl-shaped hub and the blade is formed in a smooth concave-curve shape and the tangent line to the connection part is inclined toward the rotation center, thereby enabling efficiency enhancement and noise reduction of the centrifugal fan. Thus, in the conventional centrifugal fan, flow-rate performance improvement and noise reduction are achieved by changing shapes or intervals of the blades.

### CITATION LIST

### Patent Document

Patent Document 1: Japanese Laid-Open Patent Publication No. 2010-90835

### SUMMARY OF THE INVENTION

### Problems to be Solved by the Invention

The conventional structure as disclosed in Patent Document 1 suppresses air separation occurring at a negative-pressure surface of the blade in a rotation region particularly around a low rotation region, and thus can reduce wind sound generated by the centrifugal fan.

However, in the conventional-structure centrifugal fan, if operation is performed over a wide rotation region from a low rotation region to a high rotation region, wind sound increases particularly in a high rotation region, so that there is a problem of bringing a great uncomfortable feeling. In particular, a rotary electric machine has a wide operation range from a low rotation region to a high rotation region. Wind sound in a low rotation region is masked by mechanical friction sound, electromagnetic sound, and engine sound, and therefore does not stand out. However, in a high rotation region, the flow rate increases, thus causing a problem that an uncomfortable feeling against wind sound is particularly great. Further, if the flow rate is increased to cool a heat-generating part, there is a problem that an uncomfortable feeling against wind sound increases in a high rotation region.

The present disclosure has been made to solve the above conventional problems, and an object of the present disclosure is to, without reducing the flow rate in a low rotation region, reduce the flow rate generated from a centrifugal fan in a high rotation region, thus enabling reduction of wind sound (noise-level value).

### Solution to the Problems

A centrifugal fan according to the present disclosure includes: a main plate having a rotation center; and a plurality of blades extending from the main plate in a direction of a rotation axis passing the rotation center. A length direction of each blade extends from an inner circumferential side to an outer circumferential side of the main plate. Where a distance between a forward edge of the blade and the rotation center is defined as RA and a distance between the rotation center and a point C between the forward edge and a backward edge of the blade is defined as RC, at least one of the plurality of blades has the point C that satisfies RC<RA.

### Effect of the Invention

The centrifugal fan according to the present disclosure can, without reducing the flow rate in a low rotation region, reduce the flow rate generated from the centrifugal fan in a high rotation region, thus enabling reduction of a noise value.

### BRIEF DESCRIPTION OF THE DRAWINGS

FIG. 1 schematically shows the structure of a centrifugal fan according to embodiment 1.

FIG. 2 is an enlarged view of a part of the centrifugal fan according to embodiment 1.

FIG. 3 shows a wind-sound-reduction effect of the centrifugal fan according to embodiment 1.

FIG. 4 is an enlarged view of a part of a centrifugal fan according to embodiment 3.

FIG. 5 is an enlarged view of a part of a centrifugal fan according to embodiment 4.

FIG. 6 is an enlarged view of a part of a centrifugal fan according to embodiment 6.

FIG. 7 shows a wind-sound-reduction effect of a centrifugal fan according to embodiment 7.

FIG. 8 shows a wind-sound-reduction effect of a centrifugal fan according to embodiment 8.

FIG. 9 is a partial sectional view of a vehicle AC electric generator according to embodiment 9.

FIG. 10 illustrates the relationship between the radius of a casing suction portion and a blade in a case where the centrifugal fan according to embodiment 1 is attached to a vehicle AC electric generator.

FIG. 11 shows a wind-sound-reduction effect of the vehicle AC electric generator to which the centrifugal fan according to embodiment 1 is attached.

### DESCRIPTION OF EMBODIMENTS

Hereinafter, embodiments will be described with reference to the drawings. In the drawings, the same reference characters denote the same or corresponding parts. In the following embodiments, air is used as an example of a fluid. However, without limitation thereto, another gas or a liquid such as a coolant may be used.

### Embodiment 1

Hereinafter, a centrifugal fan according to embodiment 1 will be described with reference to the drawings.

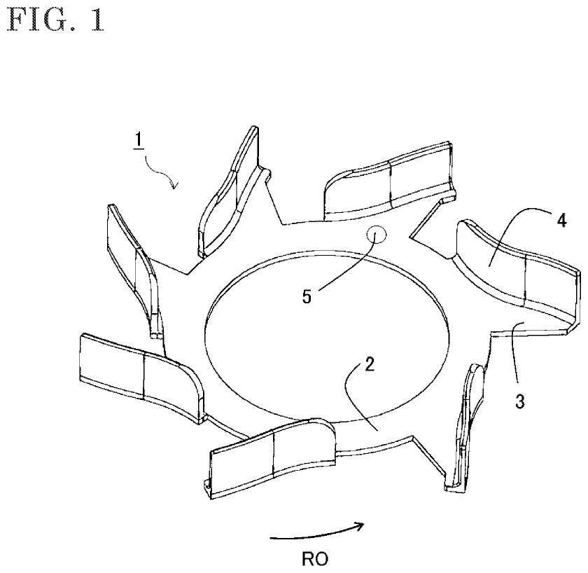

FIG. 1 is a schematic structure view showing an entire centrifugal fan 1 according to embodiment 1. The centrifugal fan 1 includes a main plate 2, a plurality of arm-shaped plates 3 extending from the main plate 2, and a plurality of blades 4.

The main plate 2 is attached to a rotary body, e.g., a rotor of a rotary electric machine described later. The main plate 2 may have a substantially plate-like shape (e.g., disk shape), a shape in which a protrusion such as a rib is provided to a plate, or a shape bulging at a rotation center O in a bowl shape. A cutout may be provided between the adjacent blades 4. As shown in FIG. 1, the main plate 2 has a ring shape for forming a hole through which a shaft 34 (see embodiment 9 described later) corresponding to the rotation axis of a rotary electric machine or the like passes, at the plate center. A part around the center hole of the main plate 2 may swell, or may be provided with a protrusion for increasing the strength. At this part, a cutout or the like for positioning relative to a rotor may be provided.

The arm-shaped plate 3 is a portion extending from a part of the main plate 2 and is flush with the outer circumference of the main plate 2. The arm-shaped plate 3 may be provided with a rib or the like for increasing the strength. An outer circumferential part of the main plate 2 may be present between two adjacent arm-shaped plates 3, or the adjacent arm-shaped plates 3 may be connected to each other so that an outer circumferential part of the main plate 2 is not present therebetween.

The rotation center O is present in the vicinity of the center of the ring shape of the main plate 2. As described above, the shaft 34 (described later) corresponding to the rotation axis perpendicular to the main surface of the main plate 2 is provided so as to pass the rotation center O.

A cooling hole 5 may be provided in the main plate 2 or the arm-shaped plate 3 extending from the main plate 2. The shape of the cooling hole 5 may be a circular shape, an elliptic shape, or a substantially polygonal shape. A plurality of cooling holes 5 may be provided. In a case of providing a plurality of cooling holes 5, the shapes of the cooling holes 5 may have different shapes. At the cooling hole 5, for reducing the flow-pass resistance of a flow sucked into a rotor 8 described later, an end part of the cooling hole 5 on the blade 4 side may be rounded or chamfered.

With the above structure, the centrifugal fan operates such that, when the main plate 2 rotates in a rotation direction RO, wind is generated so as to be discharged to outside along the blades 4 and air flowing into the center part of the main plate 2 is discharged to the outer circumferential side. The inner side (rotation center O side) of the blade 4 is a negative-pressure surface, and the outer side of the blade 4 is a positive-pressure surface where an air flow is discharged. The height of the blade 4 in the rotation-axis direction is small at a forward edge in the rotation direction and is great at a backward edge, thus making such a shape that relaxes collision of wind at the forward edge. An annular shroud may be provided on the side opposite to the main plate 2 on which the blades 4 are formed.

The cooling hole 5 may be provided in every arm-shaped plate 3 or may be provided in only one arm-shaped plate 3. Besides formation of the cooling hole 5, a part in the radial direction of the arm-shaped plate 3 may be thinned so as to increase air flowing in the axial direction. For example, the arm-shaped plate 3 in which the cooling hole 5 is not provided may be provided with a cutout at a forward or backward edge in the rotation direction, whereby air flowing in the axial direction can be increased. Desirably, the centrifugal fan 1 is arranged so that air passes through the cooling hole 5 and then readily flows in the direction opposite to the bending direction of the blade 4.

The air having passed through the cooling hole 5 moves toward the rotation-axis direction while partially flowing in the centrifugal direction as the main plate 2 rotates. In addition, providing the cooling hole 5 in the main plate 2 or the arm-shaped plate 3 can reduce the weight. Further, by providing more cooling holes 5 at a part where the arm-shaped plates 3 are provided densely, the center of gravity of the centrifugal fan 1 can be made close to the rotation center O, thus providing an effect of correcting imbalance.

The blade 4 extends from the inner circumferential side to the outer circumferential side, the inner circumferential side close to the rotation center O is the forward side in the rotation direction, and the outer circumferential side is the backward side in the rotation direction. Such blades 4 are generally called backward blades and form a so-called turbofan. In this case, the blades 4 form the centrifugal fan 1 that sucks air from the axial direction and blows out the air around the entire circumference.

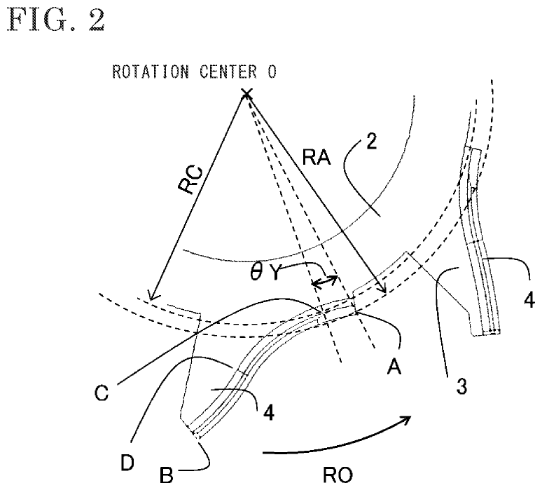

FIG. 2 shows a part of the centrifugal fan 1 as seen from the suction side in the rotation-axis direction, and is a schematic view showing the shapes of the blades 4. As shown in FIG. 2, the inner circumferential side of the blade 4 has a concave shape toward the rotation direction and the outer circumferential side thereof has a convex shape toward the rotation direction, thus forming a shape in which the concave shape on the inner circumferential side and the convex shape on the outer circumferential side are smoothly connected at an inflection point D in FIG. 2. In the centrifugal fan 1 according to the present embodiment 1, regarding at least one of the plurality of blades 4, where the distance between a forward edge A of the blade 4 and the rotation center O is defined as RA, the distance between a backward edge B of the blade 4 and the rotation center O is defined as RB, a point located between the forward edge A and the backward edge B on a curved surface of the blade 4 is defined as C, and the distance between the point C and the rotation center O is defined as RC, the blade 4 has the point C that satisfies RC<RA. The other blades are set to satisfy RA≤RC. Thus, the flow rate generated in a high rotation region of the centrifugal fan 1 is reduced, whereby wind sound can be reduced. Since at least one blade 4 has the point C that satisfies RC<RA, the flow rate generated in a high rotation region is reduced, whereby wind sound can be reduced. That is, when a flow sucked from the rotation-axis direction moves along the blade 4 so that the flow direction changes to the centrifugal direction, the flow separates from the blade 4 near the point C on the inner circumferential side. At this time, the separation can be promoted at the blade having the point C that satisfies RC<RA. Thus, the flow rate is significantly reduced, whereby wind sound can be reduced.

Here, the point C is a point at which the distance between the blade and the rotation center O is smallest, and the blade shape between the forward edge A and the point C may be a straight shape or a curved shape. In FIG. 2, the inflection point D is represented as a point. However, the inflection point D may be represented as a line tangent to both of the inner-circumferential-side concave shape and the outer-circumferential-side convex shape. In particular, in a case where the rotation speed of the centrifugal fan 1 is high, by reducing the flow rate, it is possible to significantly reduce wind sound as compared to a conventional centrifugal fan in which all the blades satisfy RA≤RC and do not have such a point C that satisfies RC<RA.

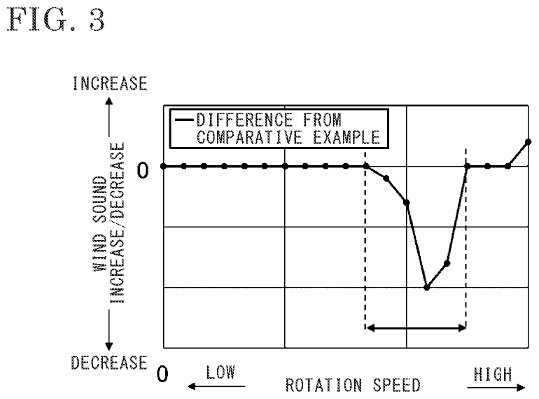

FIG. 3 illustrates a wind-sound-reduction effect of the centrifugal fan 1 according to embodiment 1. The horizontal axis indicates the rotation speed, and the vertical axis indicates increase/decrease in wind sound relative to a centrifugal fan as a comparative example which has no such point C that satisfies RC<RA. In FIG. 3, it is found that wind sound is reduced in a high rotation region where separation of a flow is likely to occur.

Although the example in which one blade of the centrifugal fan 1 has the point C that satisfies RC<RA is shown here, a plurality of blades 4 may have the points C that satisfies RC<RA. The blades can be formed without significant cost increase.

As described above, according to embodiment 1, in the centrifugal fan 1 including the main plate 2 having the rotation center O and the plurality of blades 4 extending from the main plate 2 in the direction of the rotation axis passing the rotation center O, the length direction of each blade 4 extends from the inner circumferential side to the outer circumferential side of the main plate 2, and where the distance between the forward edge of the blade 4 and the rotation center O is defined as RA and the distance between the rotation center O and the point C between the forward edge and the backward edge of the blade 4 is defined as RC, at least one of the plurality of blades 4 has the point C that satisfies RC<RA. Thus, separation of an air flow from the blade 4 near the point C is promoted and the flow rate generated from the centrifugal fan is reduced in a high rotation region, whereby wind sound (noise-level value) can be reduced.

The blades 4 may not necessarily have flat surfaces. For example, in FIG. 1, each blade 4 has such a curved surface that, as seen from the outer side, an inner-circumferential-side surface is concave and an outer-circumferential-side surface is convex and these surfaces are smoothly connected to each other, but another surface shape may be employed. The blades 4 have shapes that stand approximately orthogonally from the outer circumferential side of the arm-shaped plate 3. Therefore, the blades 4 are approximately parallel to the rotation axis. However, the standing directions of the blades 4 may not necessarily be orthogonal to the main plate 2, and may have a certain angle with respect to the main plate 2. That is, the blades 4 may have such shapes that, partially or in all, incline at appropriate angles with respect to the rotation axis, and the shapes of the blades 4 may be straight shapes, arc shapes, or S shapes as seen in the axial direction.

The blades 4 may be arranged at equal intervals or unequal intervals in the rotation direction, and the blade shapes of the blades 4 may be the same or may be a combination of a plurality of blade shapes. In a case where the blades 4 are arranged at unequal intervals, the positions of the arm-shaped plates 3 may be arranged at unequal intervals in the rotation direction, and two adjacent arm-shaped plates 3 may be formed such that the ring-shaped part of the main plate 2 is not exposed therebetween. That is, the base parts of the two arm-shaped plates 3 connecting to the main plate 2 may be partially connected to each other. Here, the unequal intervals are defined such that, as seen in the rotation-axis direction, an angle formed by the outer circumferential ends of the adjacent blades with respect to the rotation center O is not the same among the blades.

The blade 4 has a shape that bends from the outer circumferential side of the arm-shaped plate 3 extending in the radial direction and stands in the axial direction, and thus has a structure that can be easily formed through continuous plate bending work (sheet metal working), for example. However, the blade 4 may not necessarily be formed at an outer circumferential end of the main plate 2.

### Embodiment 2

Hereinafter, a centrifugal fan according to embodiment 2 will be described.

In the above embodiment 1, for at least one blade, the blade shape on the inner circumferential side is set to have the point C that satisfies RC<RA. However, the blade shape may be set such that, between the forward edge A and the point C, the distance between the blade 4 and the rotation center O monotonically decreases from the forward edge A. With this structure, a flow at the negative-pressure surface of the blade 4 between the forward edge A and the point C of the blade 4 is stabilized, and between the forward edge A and the point C, separation of an air flow can be suppressed. Thus, separation occurring near the point C can be easily controlled, whereby it becomes possible to control the rotation speed at which the wind-sound-reduction effect is provided.

### Embodiment 3

Hereinafter, a centrifugal fan according to embodiment 3 will be described with reference to the drawings.

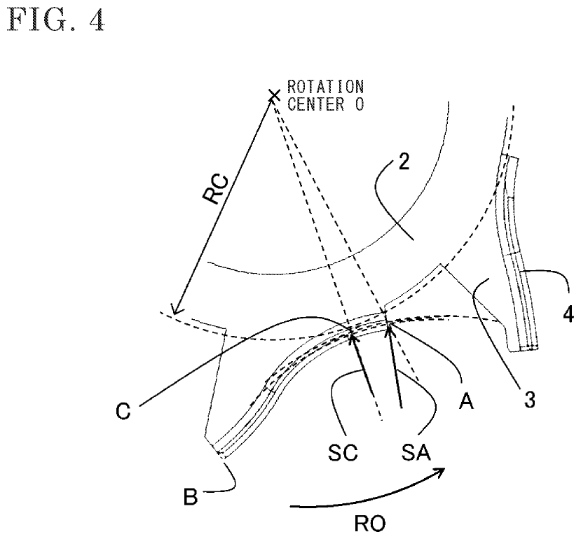

FIG. 4 shows a part of the centrifugal fan 1 according to embodiment 3. In the above embodiment 1, the blade shape on the inner circumferential side is prescribed using a distance from the rotation center O, whereas in the present embodiment 3, the blade shape is prescribed using a curvature radius. As shown in FIG. 4, where the curvature radius of the blade at the forward edge A is defined as SA and the curvature radius at the point C is defined as SC, the blade shape may be set such that the curvature radius of the blade gradually decreases from the forward edge A toward the point C, i.e., SC<SA is satisfied between the forward edge A and the point C. With the blade 4 having the point C set as described above, a flow at the negative-pressure surface of the blade 4 between the forward edge A and the point C of the blade 4 is stabilized, and between the forward edge A and the point C, separation of an air flow can be suppressed.

As described above, according to embodiment 3, the same effects as in embodiments 1 and 2 are provided. That is, in the centrifugal fan 1, for at least one blade, the blade shape on the inner circumferential side is set such that the curvature radius SC at the point C between the forward edge and the backward edge is smaller than the curvature radius SA of the blade at the forward edge A, and the curvature radius of the blade gradually decreases from the forward edge A toward the point C. Therefore, a flow at the negative-pressure surface of the blade 4 between the forward edge A and the point C of the blade 4 is stabilized, and between the forward edge A and the point C, separation of an air flow can be suppressed. Thus, separation occurring near the point C can be easily controlled, whereby it becomes possible to control the rotation speed at which the wind-sound-reduction effect is provided.

### Embodiment 4

Hereinafter, a centrifugal fan according to embodiment 4 will be described with reference to the drawings.

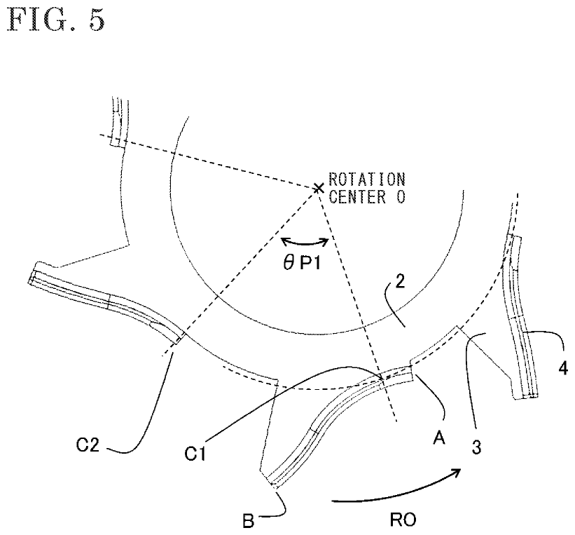

FIG. 5 shows a part of the centrifugal fan 1 according to embodiment 4. In the above embodiment 1, for a certain blade, the blade shape on the inner circumferential side is prescribed using a distance from the rotation center O. Alternatively, as shown in FIG. 5, the plurality of blades 4 (the number of which is m: m is a natural number and the total number of the blades) provided to the centrifugal fan 1 may be further prescribed using an interval between the adjacent blades 4.

In FIG. 5, on each of the plurality of blades 4 composing the centrifugal fan 1, a point closest to the rotation center O is defined as Cn (n: a natural number that satisfies 1≤n≤m, n returning to 1 after m). Only one blade 4 has the point C that satisfies RC<RA, the other blades 4 satisfy RA≤RC, and the point C that satisfies RC<RA is defined as C1. In the opposite-rotation-direction order from the blade 4 having the point C1, points of the respective blades 4 that are closest to the rotation center O are defined as C1, C2, . . . , Cn, . . . , Cm, and an angle formed with respect to the rotation center O by the point Cn of the nth blade and the point C(n+1) of the blade adjacent thereto in the opposite rotation direction is defined as an adjacent-blade interval θPn. Then, the blades 4 are arranged such that θP1 is greatest of the blade intervals θPn. That is, only the blade on the forward side in the rotation direction of the blades forming the greatest θPn, i.e., only the blade 4 having the point C1 is set to satisfy RC<RA. With this structure, the flow rate generated in a high rotation region of the centrifugal fan 1 is reduced especially effectively, whereby wind sound can be reduced. That is, if a flow separated from the blade 4 having the point C1 collides and contacts again with the adjacent blade 4 having the point C2, wind sound increases, but with the above structure, a flow separated from the blade 4 having the point C1 is readily discharged in the circumferential direction, whereby increase in wind sound can be prevented.

As described above, according to embodiment 4, among the plurality of blades 4 composing the centrifugal fan 1, the blade 4 on the forward side in the rotation direction of the blades forming the blade interval θP1 that is the greatest adjacent-blade interval θPn is set to satisfy RC<RA, and the other blades are set to satisfy RA≤RC. Thus, in addition to the effects of embodiment 1, an air flow separated from the blade 4 that satisfies RC<RA is readily discharged in the circumferential direction. Further, the flow separated from the blade 4 that satisfies RC<RA is inhibited from colliding and contacting again with the blade 4 on the backward side in the rotation direction, whereby increase in wind sound due to the flow contacting with the blade again can be suppressed.

### Embodiment 5

Hereinafter, a centrifugal fan according to embodiment 5 will be described.

In the above embodiment 4, the blade on the forward side in the rotation direction of the blades forming the greatest adjacent-blade interval θP1 is set to satisfy RC<RA, and the other blades 4 are set to satisfy RA≤RC. However, the number of blades 4 set to satisfy RC<RA is not limited to one.

For each blade (i.e., Cn) on the forward side in the rotation direction at θPn, a plurality of blades 4 in a descending order of θPn may be set to satisfy RC<RA, and the other blades may be set to satisfy RA≤RC. For example, in a case where the second greatest blade interval is θP4 and the third greatest blade interval is θP7, the fourth blade 4 from the blade 4 having the point C1 is set to have the point C4, the seventh blade 4 from the blade 4 having the point C1 is set to have the point C7 that satisfies RC<RA, and the other blades are set to satisfy RA≤RC. With this structure, the flow rate generated in a high rotation region of the centrifugal fan 1 is reduced more effectively, whereby wind sound can be reduced.

In the case where the plurality of blades 4 are set to satisfy RC<RA, the distances RC of the respective blades 4 may be set to be different from each other. By changing the distances RC for the plurality of blades 4 as described above, high rotation regions where wind sound reduction occurs can be shifted, whereby wind sound reduction is achieved over a wide rotation region.

As described above, according to embodiment 5, among the plurality of blades 4 composing the centrifugal fan 1, some blades have the points C that satisfy RC<RA. The blade 4 on the forward side in the rotation direction of the blades forming the blade interval θP1 that is the greatest adjacent-blade interval θPn is set to satisfy RC<RA, and in a descending order of the blade interval θPn, each blade 4 on the forward side in the rotation direction is set to satisfy RC<RA. The other blades 4 are set to satisfy RA<RC. Thus, as compared to embodiment 4, the flow rate generated in a high rotation region of the centrifugal fan 1 is further reduced, whereby the wind-sound-reduction effect can be further provided.

### Embodiment 6

Hereinafter, a centrifugal fan according to embodiment 6 will be described with reference to the drawings.

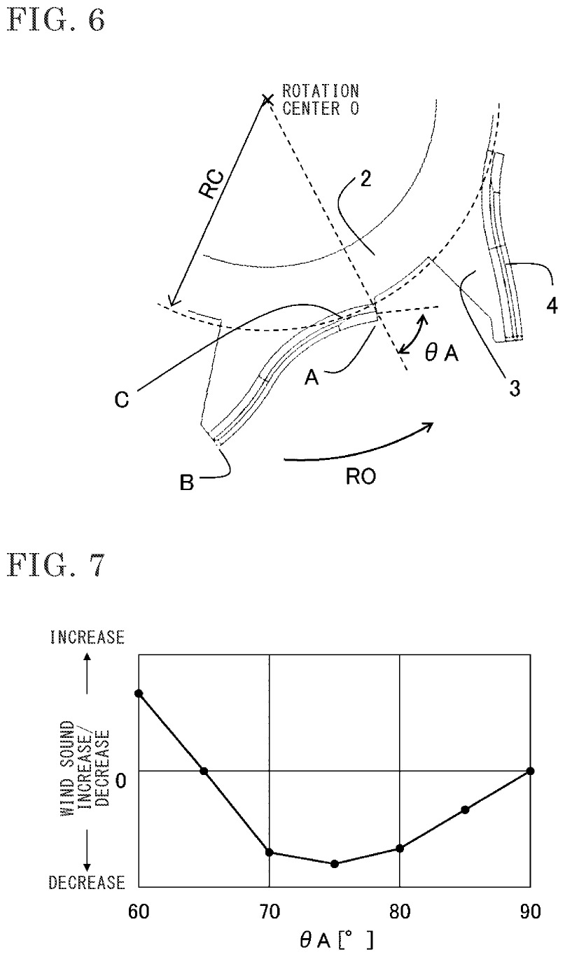

FIG. 6 shows a part of the centrifugal fan 1 according to embodiment 6. In the above embodiment 1, for a certain blade 4, the blade shape on the inner circumferential side is prescribed using a distance from the rotation center O. Alternatively, as shown in FIG. 6, the blade shape on the inner circumferential side may be prescribed using an angle θA formed by a half line connecting the rotation center O and the forward edge A of the blade 4 and a tangent line at the forward edge A of the blade 4.

If at least one of the plurality of blades 4 is set to satisfy θA<90°, the set blade 4 has, between the forward edge and the backward edge, such a point C that the distance thereof to the rotation center O is smaller than the distance RA between the rotation center O and the forward edge A of the blade 4, whereby a flow at the negative-pressure surface of the blade 4 between the forward edge and the backward edge is stabilized, and between the forward edge A and the point C, separation of an air flow can be suppressed. Thus, separation occurring near the point C can be easily controlled, whereby it becomes possible to control the rotation speed at which the wind-sound-reduction effect is provided.

The number of blades 4 prescribed to satisfy θA<90° is not limited to one.

As described above, according to embodiment 6, the same effects as in embodiment 1 are provided. That is, in the centrifugal fan 1, for at least one blade, the angle θA formed by a half line connecting the rotation center O and the forward edge A of the blade 4 and the tangent line at the forward edge A of the blade 4 is prescribed to satisfy θA<90°, whereby a flow at the negative-pressure surface of the blade 4 between the forward edge A and the point C of the blade 4 is stabilized, and between the forward edge A and the point C, separation of an air flow can be suppressed. Thus, separation occurring near the point C can be easily controlled, whereby it becomes possible to control the rotation speed at which the wind-sound-reduction effect is provided.

### Embodiment 7

Hereinafter, a centrifugal fan according to embodiment 7 will be described.

In the above embodiment 6, for at least one blade in the centrifugal fan 1, the angle θA formed by a half line connecting the rotation center O and the forward edge A of the blade 4 and the tangent line at the forward edge A of the blade 4 is prescribed to satisfy θA<90°. Here, if θA is set to satisfy 65°<θA<90°, wind sound can be reduced more effectively. That is, the flow rate generated in a high-rotation-speed region of the centrifugal fan 1 is reduced, whereby wind sound can be reduced. Further, if the blade 4 that satisfies 70°<θA<80° is provided, the flow rate generated in a high-rotation-speed region of the centrifugal fan 1 is reduced especially effectively, whereby wind sound can be reduced.

FIG. 7 illustrates the wind-sound-reduction effect of the centrifugal fan 1 according to embodiment 7. The horizontal axis indicates θA and the vertical axis indicates increase/decrease in wind sound relative to a centrifugal fan as a comparative example in which the angles θA of all the blades are 90°, i.e., there is no such point C that satisfies RC<RA. In FIG. 7, it is found that wind sound is reduced when θA is in a range of 65°<θA<90° and this effect is particularly significant in a range of 70°<θA<80°. This is because a phenomenon in which a flow separated from the blade 4 near the point C contacts again with the outer circumferential side of the blade 4 and thus the wind-sound-reduction effect is reduced, is suppressed.

With the above structure, at the blade 4 of which θA satisfies 65°<θA<90°, a phenomenon in which a flow separated near the point C collides and contacts again with the blade on the backward side in the rotation direction and thus wind sound is increased, can be prevented, whereby wind sound can be effectively reduced in a high rotation region. This effect is more significant at the blade 4 that satisfies 70°<θA<80°.

### Embodiment 8

Hereinafter, a centrifugal fan according to embodiment 8 will be described with reference to the drawings.

In the above embodiment 1, for at least one blade in the centrifugal fan 1, the blade shape on the inner circumferential side is set to have the point C that satisfies RC<RA. Alternatively, as shown in FIG. 2, the angle formed by a half line connecting the forward edge A and the rotation center O and a half line connecting the rotation center O and the point C at the smallest distance on the blade may be prescribed as θY. That is, for the blade 4 having the point C that satisfies RC<RA, if θY satisfies 0° <θY<10°, the flow rate generated in a high rotation region of the centrifugal fan 1 is effectively reduced, whereby wind sound can be reduced.

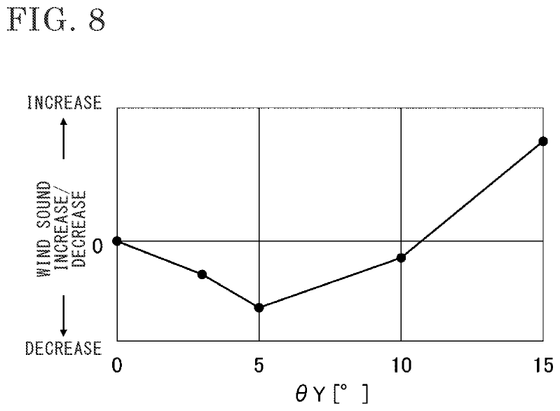

FIG. 8 illustrates the wind-sound-reduction effect of the centrifugal fan 1 according to embodiment 7. The horizontal axis indicates θY and the vertical axis indicates increase/decrease in wind sound relative to a centrifugal fan as a comparative example in which the angles θY of all the blades are 0°, i.e., there is no such point C that satisfies RC<RA. In FIG. 8, it is found that wind sound is reduced when θY is in a range of 0°<θY<10°. It is found that this effect is particularly significant when θY is in a range of 3° θY 8°. On the other hand, if θY is greater than 10°, i.e., if the point C is too far from the forward edge, the effect of suppressing separation of an air flow is reduced.

As described above, according to embodiment 8, for the blade 4 having the point C that satisfies RC<RA in the centrifugal fan 1, θY is set to satisfy 0°<θY<10°. Thus, the flow rate generated in a high rotation region of the centrifugal fan 1 is effectively reduced, whereby wind sound can be reduced. This effect is more significant at the blade 4 that satisfies 3° θY 8°.

### Embodiment 9

The centrifugal fans according to any of the above embodiments 1 to 8 may be used by being mounted to a rotor of a rotary electric machine such as an AC electric generator, a motor, or a drive device. Embodiment 9 shows an example in which the centrifugal fan is mounted to a vehicle AC electric generator.

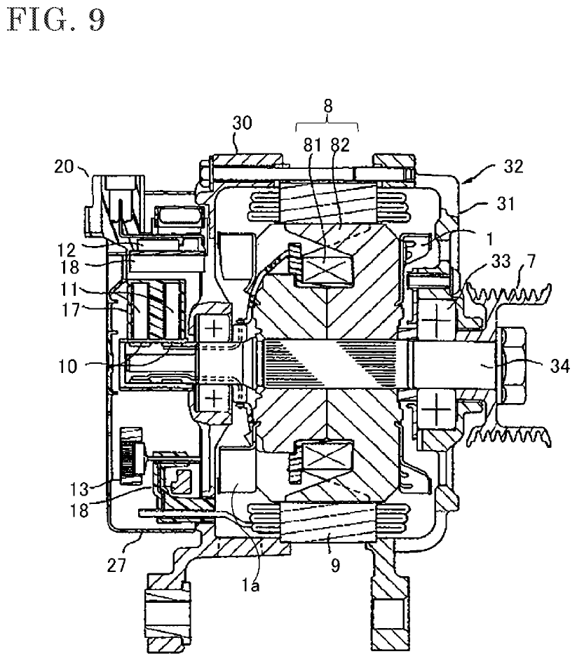

FIG. 9 is a sectional view schematically showing a vehicle AC electric generator to which the centrifugal fan 1 disclosed in any of the above embodiments 1 to 8 is applied. In FIG. 9, the vehicle AC electric generator includes: a casing 32 composed of a front-side housing 31 and a rear-side housing 30 having substantially bowl shapes and made of aluminum; a shaft 34 rotatably supported by the casing 32 via a pair of bearings 33; a pulley 7 fixed to an end of the shaft 34 extending on the front side of the casing 32; a rotor 8 which rotates integrally with the shaft 34 and is provided in the casing 32; a stator 9 provided so as to be opposed to the outer circumference of the rotor 8, and fixed to the casing 32; a pair of slip rings 10 which are fixed to an extending portion of the shaft 34 extending on the rear side of the casing 32 and supply current to the rotor 8; a pair of brushes 11 sliding on the surfaces of the respective slip rings 10; a brush holder 17 storing these brushes 11; a voltage adjuster 12 which is adjacent to the brushes 11 and adjusts the magnitude of AC voltage generated at the stator 9; a rectifier 13 rectifying the AC voltage generated at the stator 9 to DC voltage; a heat sink 18; a connector 20 through which signals are inputted/outputted between the voltage adjuster 12 and an external device (not shown); and a protection cover 27 covering the brush holder 17 and the rectifier 13.

The rotor 8 is a Lundell-type rotor including a field winding 81 which is formed by cylindrically and concentrically winding a copper wire having undergone insulation treatment and generates a magnetic flux when exciting current flows therethrough, and a field core 82 in which magnetic poles are formed by the generated magnetic flux, and which is provided so as to surround the field winding 81 and has, on both sides, claw portions whose number is 6, 8, 10, or a greater value that is an integer multiple of 2.

The centrifugal fan 1 is provided such that the shaft 34 is inserted through the hole at the center part of the main plate 2 of the centrifugal fan 1, and is attached to the rotor 8 by welding or the like. The centrifugal fan 1 has the features described in the above embodiments 1 to 8, and sucks the outside air into the vehicle AC electric generator through rotation of the rotor 8, and discharges the air that has cooled components in the vehicle AC electric generator. In detail, the rotor 8 is provided with a flow passage for cooling the field winding 81, and a fluid flows in the axial direction as the rotor 8 and the centrifugal fan 1 rotate, thereby cooling the field winding 81. By providing the centrifugal fan 1 having the features described in the above embodiments to the rotor, cooling performance is improved.

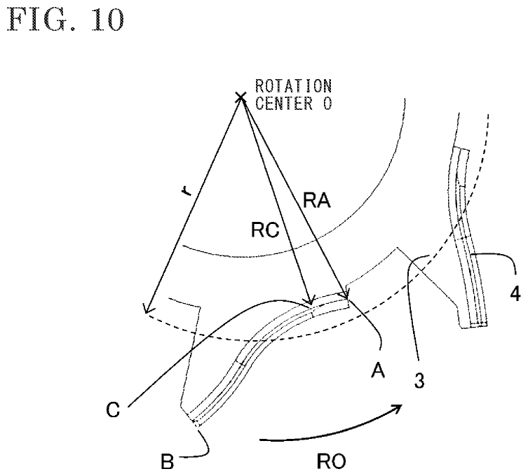

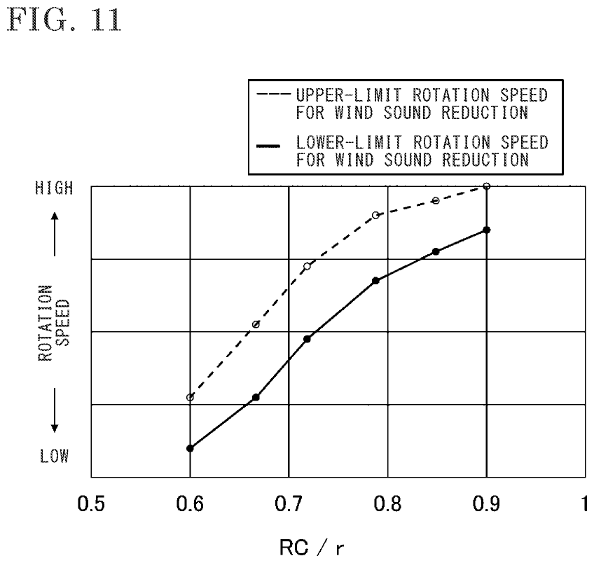

FIG. 10 illustrates the relationship between the radius of a casing suction portion and the blade in a case where the centrifugal fan 1 according to embodiment 1 is attached to the vehicle AC electric generator, as an example, and shows a view of the centrifugal fan 1 as seen from the pulley 7 side of the shaft 34 passing the rotation center O. In FIG. 10, where the outer radius of the suction portion of the casing 32 is defined as r, the blade 4 of the centrifugal fan 1 is set to satisfy RC<r, whereby wind sound can be reduced. Further, if the blade is set to satisfy RC<RA<r, the wind-sound-reduction effect can be enhanced. Here, the radius r of the suction portion of the casing 32 is the outer radius of the suction portion when the front-side housing 31 is seen from the pulley 7 side, with respect to the centrifugal fan 1.

With this structure, the influence of disturbance occurring at the suction portion of the casing 32 can be reduced. Therefore, separation occurring near the point C on the blade 4 located at the shortest distance from the rotation center O can be easily controlled, and thus wind sound increase caused when a flow separated near the point C contacts again with the blade 4 can be suppressed.

FIG. 11 shows the wind-sound-reduction effect in the case where the centrifugal fan 1 according to embodiment 1 is attached to the vehicle AC electric generator. In FIG. 11, the horizontal axis indicates RC/r, i.e., the ratio of the distance RC between the rotation center and the point C to the outer radius of the suction portion of the casing 32, and the vertical axis indicates the rotation speed of the centrifugal fan. A solid line indicates a lower-limit rotation speed at which wind sound reduction occurs, and a broken line indicates an upper-limit rotation speed at which wind sound reduction occurs. The wind-sound-reduction effect is obtained at a rotation speed between the solid line and the broken line. As shown in FIG. 11, as RC/r increases, the rotation speed at which wind sound reduction occurs can be increased. That is, it is found that, even in a high-rotation-speed region where the flow rate is increased for cooling, wind sound can be reduced by appropriately setting RC/r.

In the above embodiment 9, the centrifugal fan 1 and the front-side housing 31 of the casing 32 have been described. However, the above configuration may be applied to a centrifugal fan 1a provided on the rear side and the outer radius of a suction portion of the rear-side housing 30 of the casing 32, or may be applied to both of the centrifugal fan 1 and the centrifugal fan 1a. In a case of applying the above configuration to the rear-side fan, the radius r of the suction portion is the outer radius of the suction portion of the rear-side housing 30 as seen from the brush 11 side.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1, 1a centrifugal fan
2 main plate
3 arm-shaped plate
4 blade
5 cooling hole
7 pulley
8 rotor
9 stator
10 slip ring
11 brush
12 voltage adjuster
13 rectifier
17 brush holder
18 heat sink
20 connector
27 protection cover
30 rear-side housing
31 front-side housing
32 casing
33 bearing
34 shaft
81 field winding
82 field core

1. A centrifugal fan comprising:
a main plate having a rotation center; and
a plurality of blades extending from the main plate in a direction of a rotation axis passing the rotation center, wherein
a length direction of each blade extends from an inner circumferential side to an outer circumferential side of the main plate, and
where a distance between a forward edge of the blade and the rotation center is defined as RA and a distance between the rotation center and a point C between the forward edge and a backward edge of the blade is defined as RC, at least one of the plurality of blades has the point C that satisfies RC<RA.

2. The centrifugal fan according to claim 1, wherein
the blade having the point C that satisfies RC<RA is formed such that a distance between the blade and the rotation center monotonically decreases from the forward edge toward the point C.

3. The centrifugal fan according to claim 1, wherein
the blade having the point C that satisfies RC<RA is formed such that a curvature radius of the blade decreases from the forward edge toward the point C.

4. The centrifugal fan according to claim 1, wherein
where, on each of the plurality of blades, a point at a smallest distance from the rotation center is defined as C, and angles formed with respect to the rotation center by the points C of the blades adjacent in an opposite rotation direction in an order from the blade having the point C that satisfies RC<RA are defined as θP1 . . . θPm, m being a natural number and a total number of the blades, the plurality of blades are arranged such that the angle θP1 is greatest, and only the blade forming the angle θP1 satisfies RC<RA.

5. The centrifugal fan according to claim 4, wherein
two or more of the plurality of blades have the points C that satisfy RC<RA, and the blades are arranged such that the angles formed with respect to the rotation center by the points C of the blades adjacent in the opposite rotation direction among the blades having the points C that satisfy RC<RA are in a descending order in the opposite rotation direction from the angle θP1.

6. The centrifugal fan according to claim 5, wherein
the distances RC of the two or more blades having the points C that satisfy RC<RA are different from each other.

7. The centrifugal fan according to claim 1, wherein
for the blade having the point C that satisfies RC<RA, where an angle formed by a half line connecting the rotation center and the forward edge of the blade and a tangent line at the forward edge of the blade is defined as θA, θA satisfies 65°<θA<90°.

8. The centrifugal fan according to claim 7, wherein
θA satisfies 70°<θA<80°.

9. The centrifugal fan according to claim 1, wherein
for the blade having the point C that satisfies RC<RA, where an angle formed by a half line connecting the forward edge of the blade and the rotation center and a half line connecting the point C and the rotation center is defined as θY, θY satisfies 0°<θY<10°.

10. The centrifugal fan according to claim 9, wherein
θY satisfies 3°<θY<8°.

11. A rotary electric machine comprising:
the centrifugal fan according to claim 1; and
a rotor to which the centrifugal fan is attached, wherein
the point C of the blade having the point C that satisfies RC<RA is located toward the inner circumferential side relative to a radius of a suction portion of a casing covering the rotor and the centrifugal fan.

12. The rotary electric machine according to claim 11, wherein
the forward edge of the blade having the point C that satisfies RC<RA is located toward the inner circumferential side relative to the radius of the suction portion of the casing.

13. A rotary electric machine comprising:
the centrifugal fan according to claim 2; and
a rotor to which the centrifugal fan is attached, wherein
the point C of the blade having the point C that satisfies RC<RA is located toward the inner circumferential side relative to a radius of a suction portion of a casing covering the rotor and the centrifugal fan.

14. A rotary electric machine comprising:
the centrifugal fan according to claim 3; and
a rotor to which the centrifugal fan is attached, wherein
the point C of the blade having the point C that satisfies RC<RA is located toward the inner circumferential side relative to a radius of a suction portion of a casing covering the rotor and the centrifugal fan.

15. A rotary electric machine comprising:
the centrifugal fan according to claim 4; and
a rotor to which the centrifugal fan is attached, wherein
the point C of the blade having the point C that satisfies RC<RA is located toward the inner circumferential side relative to a radius of a suction portion of a casing covering the rotor and the centrifugal fan.

16. A rotary electric machine comprising:
the centrifugal fan according to claim 7; and
a rotor to which the centrifugal fan is attached, wherein
the point C of the blade having the point C that satisfies RC<RA is located toward the inner circumferential side relative to a radius of a suction portion of a casing covering the rotor and the centrifugal fan.

17. The rotary electric machine according to claim 13, wherein
the forward edge of the blade having the point C that satisfies RC<RA is located toward the inner circumferential side relative to the radius of the suction portion of the casing.

18. The rotary electric machine according to claim 14, wherein
the forward edge of the blade having the point C that satisfies RC<RA is located toward the inner circumferential side relative to the radius of the suction portion of the casing.

19. The rotary electric machine according to claim 15, wherein
the forward edge of the blade having the point C that satisfies RC<RA is located toward the inner circumferential side relative to the radius of the suction portion of the casing.

20. The rotary electric machine according to claim 16, wherein
the forward edge of the blade having the point C that satisfies RC<RA is located toward the inner circumferential side relative to the radius of the suction portion of the casing.
